(19) United States
(12) Patent Application Publication
(10) Pub. No.: US 2003/0129059 A1
(43) Pub. Date: Jul. 10, 2003

(54) Mechanism for controlling independently the pitch of each of a plurality of blades of a wind turbine

(75) Inventor: Goran Nord, Manstad (SE)

Correspondence Address: Peter K. Sommer, Esq., Phillips, Lytle, Hitchcock, Blaine & Huber LLP, Intellectual Property Group, 3400 HSBC Center, Buffalo, NY, 14203, US

(73) Assignee: Moog Inc.

(21) Appl. No.: 10/037,408

(22) Filed: Jan. 4, 2002

(51) Int. Cl. F03D 7/02

(52) U.S. Cl. 416/160; 416/162

(57) ABSTRACT

A mechanism (16) for controlling independently the pitch of a plurality of blades (15A, 15B, 15C) of a wind turbine (10) includes: a hub (11) rotatable about an axis (x-x) relative to a nacelle (12); a plurality of blades mounted on the hub for rotation therewith about the hub axis, each blade having a shaft (21) and being mounted on the hub for rotation about its axis of elongation; a plurality of motors (34) mounted on the nacelle, each motor having an output shaft (35) and being associated with a respective one of the blades; and a coupling mechanism (37) operatively interposed between each motor and its associated blade for selectively rotating such blade about its axis to vary the pitch of the associated blade relative to the hub axis. The pitch of each blade may be controlled independently of the pitch of the others.

### TECHNICAL FIELD

The present invention relates generally to the field of wind turbines, and, more particularly, to improved wind turbines in which the pitch of each of a plurality of propeller blades is controllable independently of that of the other blades so as to afford the capability of cyclic pitch control of the blades as they rotate about an axis in an air stream.

### BACKGROUND ART

The present invention relates generally to wind turbines. As used herein, the term “wind turbine” may be either a member that is driven by the wind (e.g., a windmill), or a member that is rotated to create a flow of air (e.g., a variable-pitch propeller on an aircraft, a fan, etc.).

In the aircraft art, it is known to provide variable-pitch propellers. The pitch of the several propeller blades is typically controlled by a single actuator. Hence, the pitch angles of the various propeller blades are all controlled together, rather than independently.

It is also known to control the pitch of multiple blades on the hub of a windmill by means of a single motor mounted on the nacelle. For example, German Patent No. DE 42 21 783 discloses several embodiments of structure for connecting a single motor, mounted on the nacelle in a manner concentric with the hub axis of rotation, so as to selectively rotate all of the blade shafts together. In one of these embodiments, sector gears on each blade shaft are driven by gears on the radial coupling shafts, each of which is driven by a bevel gear that engages a common gear on the motor shaft concentric with the hub. Providing a hub-concentric gear on the gear train between the blade and motor is fundamental to mounting the drive motor on the non-rotating nacelle, and connecting it to the blades on the rotating hub.

Upon information and belief, it is known to provide three motors on the rotating hub to afford separate pitch control of each individual blade. However, this requires the transmission, via slip rings, brushes or the like, of electrical power and communication signals between the relatively-rotating hub and nacelle.

It would be generally desirable to provide an improved mechanism by means of which the pitch of each of a plurality of blades of a wind turbine can be controlled independently of one another so as to afford the capability of a cyclic pitch control as the blades rotate about the hub axis.

It would also be desirable to provide an improved mechanism in which a plurality of nacelle-mounted motors may controllably and individually vary the pitch of a corresponding plurality of associated hub-mounted blades, without the need for various slip rings or other forms of electrical connector between the relatively-rotating hub and nacelle.

### DISCLOSURE OF THE INVENTION

With parenthetical reference to the corresponding parts, portions or surfaces of the disclosed embodiment, merely for purposes of illustration and not by way of limitation, the present invention broadly provides an improved mechanism (16) for controlling independently the pitch of a plurality of propeller-like blades (15A, 15B, 15C) of a wind turbine (10).

The improved mechanism broadly comprises: a hub (11) rotatable about an axis (x-x) relative to a nacelle (12); a plurality of blades mounted on the hub for rotation therewith about the hub axis, each blade being mounted on the hub for rotation about its axis of elongation (y-y); a plurality of motors (34) mounted on the nacelle, each motor having an output shaft (35) and being associated with a respective one of the blades; and a coupling mechanism (37) operatively interposed between each motor and its associated blade for selectively rotating such blade about its axis to controllably vary the pitch of the associated blade relative to the hub axis; whereby the pitch of each blade may be controlled independently of that of the others.

In the preferred embodiment, the motor is an electric motor, and the blade axis is substantially perpendicular to the hub axis. The coupling mechanism may include a gear train. In the preferred embodiment, the gear train includes a first gear (24) mounted on the blade shaft, a second gear mounted on the motor shaft (39), and an intermediate ring gear (31) concentric with the hub axis and coupled to the first and second gears.

In another aspect, the invention may include a differential gear set (43) mounted on the nacelle and operatively interposed between the motor shaft and the intermediate gear. This differential gear set may include an input shaft (35) coupled to the motor shaft, an output shaft (45) coupled to the intermediate gear, and a reference shaft (42) coupled to rotate with said hub. The differential gear set is operatively arranged such that the output shaft rotation is proportional to the algebraic sum of the angular rotations of said input shaft and said reference shaft.

Accordingly, the general object of the invention is to provide an improved mechanism for controlling independently the pitch of each of a plurality of propeller-like blades of a wind turbine.

Another object is to provide an improved mechanism that will allow cyclic control of the blades of a wind turbine.

Still another object is to provide an improved mechanism in which a plurality of motors mounted on the relatively-stationary nacelle may be used to controllably vary the pitch of a corresponding plurality of blades mounted on a relatively-rotatable hub, without the need of slip rings, brushes or other forms of electrical couplings between the hub and nacelle.

These and other objects and advantages will become apparent from the foregoing and ongoing written specification, the drawings, and the appended claims.

### BRIEF DESCRIPTION OF THE DRAWINGS

FIG. 1 is a schematic front elevation of a three-blade windmill.

FIG. 2 is a greatly-enlarged fragmentary view, partly in section and partly in elevation, of the improved mechanism shown in FIG. 1, this view being taken generally on line 2-2 of FIG. 1.

FIG. 3 is a perspective view of the mechanism shown in FIG. 1, this view illustrating the gear train between a motor and blade for selectively rotating such blade about its longitudinal axis to vary the pitch of the blade relative to the air stream.

FIG. 4 is a schematic view of a second form of the improved mechanism, this view showing a differential gear set as being operatively interposed between a motor and the associated blade.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

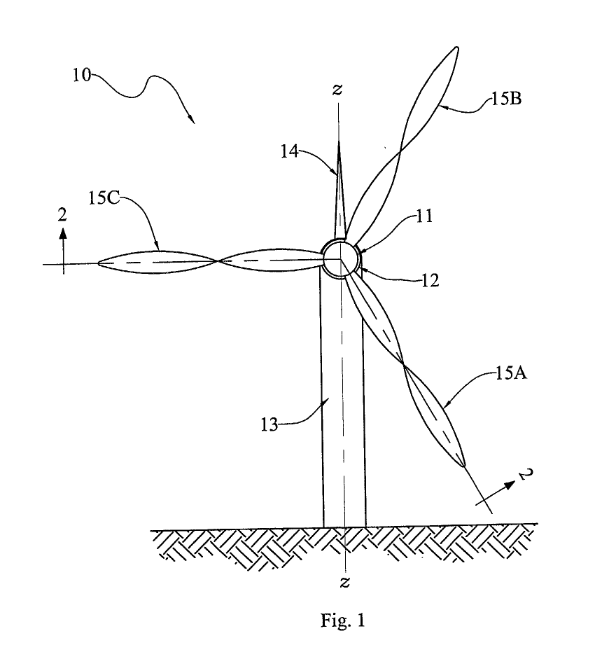

Referring now to the drawings, and, more particularly, to FIG. 1 thereof, the present invention provides an improved mechanism that is adapted to be associated with a wind turbine, such as a windmill 10. As used herein, the expression “wind turbine” broadly refers to a mechanism having a plurality of blades mounted on a hub that may be rotated relative to an air stream. In a windmill, the air stream causes rotation of the hub and blades. However, a wind turbine could also be an aircraft engine or a fan in which a motor or engine causes propellers or blades to rotate so as to create the air stream. In either case, the hub is adapted to rotate relative to an airstream to do some useful work. In a windmill (i.e., a driven wind turbine), the air stream causes the hub to rotate. In a motor-driven fan or an engine-driven propeller (i.e., a driving wind turbine), the rotating hub creates the air flow. In the following description, the invention will be described in association with a windmill. However, it should be clearly understood that this is merely illustrative, and is not limitative of the scope of the appended claims.

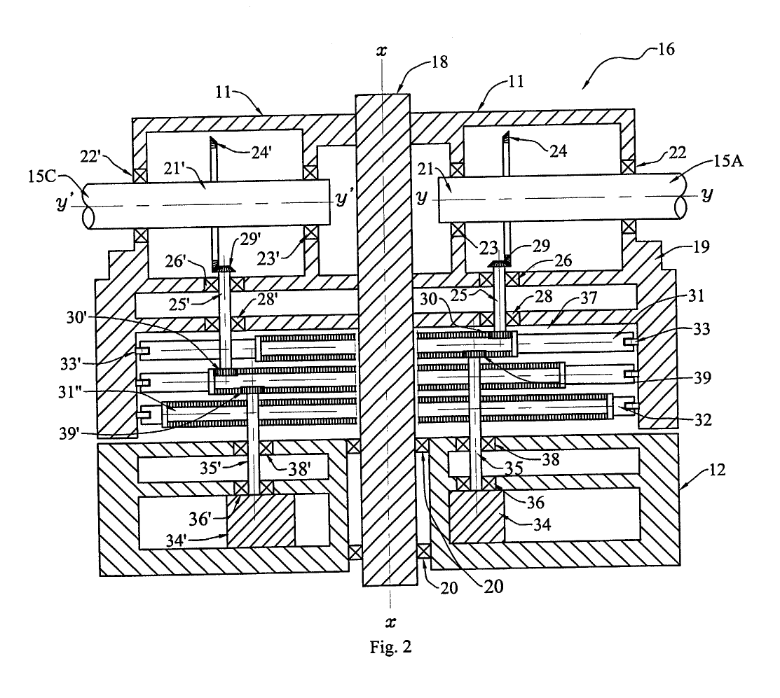

In FIG. 1, windmill 10 has a horizontal hub 11 mounted for rotation relative to a nacelle 12, which is mounted for rotation about a vertical axis z-z. The nacelle is supported on a post 13 that extends upwardly from the ground. A tail or rudder 14 is mounted on the nacelle and keeps the horizontal hub axis x-x (FIG. 2) pointed into the wind. Thus, the air flow is substantially parallel to the hub axis. The windmill shown in FIG. 1 has three blades, indicated at 15A, 15B, 15C, respectively. Of course, the windmill is used to rotate a suitable object (not shown), such as a generator, alternator or some other mechanism, to do useful work Suffice it to say that the windmill need only have a plurality (i.e., two or more) of such blades, and the specific number of blades is not deemed critical.

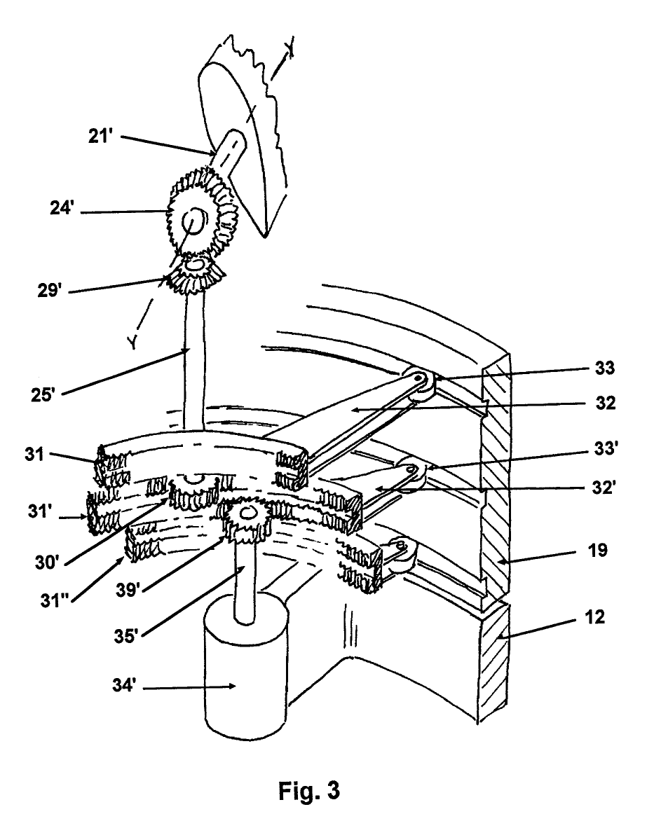

First Embodiment (FIGS. 2-3)

FIG. 2 is a fragmentary view, partly in section and partly in elevation, taken generally on line 2-2 of FIG. 1, of the improved individual pitch-control mechanism, generally indicated at 16, shown in FIG. 1. As previously indicated, the hub is generally indicated at 11, and the nacelle is generally indicated at 12. The two blades that are visible in FIG. 2 are indicated at 15A, 15C, respectively. Persons skilled in this art will appreciate that there are, in fact, three blades arranged at 120° intervals, but that only two are visible in FIG. 2 due to the angle at which cutting line 2-2 has been taken. Of course, the windmill could have a greater or smaller number of blades, as desired.

In FIG. 2, the hub is shown as having a central horizontally-elongated shaft 18 having an axis x-x. The hub also has other portions, fragmentarily indicated at 19, that are mounted fast to the shaft for rotation therewith. Only pertinent portions of hub 19 have been illustrated so as to avoid obfuscating the invention with disclosure of unnecessary structure. The hub shaft 18 is carried on the nacelle via bearings 20, 20.

Inasmuch as the mechanisms for rotating each blade are identical, only the mechanism used to rotate blade 15A will be specifically discussed. The reader will understand that the primes of the same reference numerals applied to the mechanism utilized to rotate blade 15C refer to corresponding parts, portions or surfaces of the other illustrated mechanism.

In FIG. 2, blade 15A is shown as having a shaft portion 21 adjacent its left marginal end. Blade 15A is journalled on the hub by means of bearings 22,23. A bevel gear 24 is mounted fast on the blade shaft.

A horizontally-elongated coupling shaft 25 is journalled on the hub via bearings 26,28. This coupling shaft has an upper bevel gear 29 in meshed engagement with blade gear 24. Blade gear 24 may be a toothed gear sector, if desired. At its lower end, the coupling shaft has a second gear 30 in meshed engagement with an intermediate ring gear, generally indicated at 31. Ring gear 31 is shown as having two inwardly-facing toothed portions, and as having an outer peripheral portion 32 provided with a plurality of circumferentially-spaced idler rollers 33. These idler rollers engage an inwardly-facing surface, such as a shallow track, on the hub. Ring gear 31 is not mounted fast to the hub; rather, it is arranged to be selectively rotated relative to the hub by means of the associated motor, as described infra.

A motor 34 is mounted on the nacelle. This motor has a rotatable output shaft 35 journalled on the nacelle by means of bearings 36,38. A gear 39 is mounted on the upper end of the motor output shaft, and is in meshed engagement with the ring gear 31.

Fragmentary portions of the ring gears associated with the other two blades are in-dicated at 31′ and 31″, respectively. Notice that motor 34′ is coupled to ring gear 31′. Motor 34″ (not shown) is similarly coupled to ring gear 34″. Notice also that the diameter of the toothed portion of ring gear 31 is less than that of ring gear 31′, which in turn is less than that of ring gear 31″.

Thus, the blades are mounted on the hub for rotation therewith about hub axis x-x. At the same time, each blade is mounted for rotation about its axis of elongation, indicated at y-y for blade 15A and y′-y′ for blade 15C. In the preferred embodiment, blade axis y-y is substantially perpendicular to hub axis x-x.

FIG. 3 is a perspective view illustrating the coupling of the nacelle-mounted motor 34′ to the hub-mounted blade shaft 21′. The bearing supports for shaft 21′ and coupling shaft 25′ on hub 19 are not shown. Fragmentary portions of the three intermediate ring gears, 31,31 ′ and 31″, are shown, each with one of their corresponding circumferentially-spaced radial arms 32, 32′, 32″ carrying rollers 33, 33′, 33″, respectively, running in circumferential tracks in the inner wall of the hub 19. The ring gears are shown as having progressively-larger diameters (ie., gear 31 being the smallest, gear 31′ being intermediate, and gear 31″ being the largest) and correspondingly-shorter radial arms 32, 32′, 32″ carrying rollers at the hub common track radius. In FIG. 3, motor 34′ is mounted on nacelle 12 by an appropriate support arm so as to allow gear 39′ to mesh with the teeth on the inner periphery of ring gear 31′ at its particular diameter. The radial spacing between the ring gears is such as to allow clearance for coupling shaft 25′ to pass outside of the smaller ring gear 31′ and to provide for engagement of gear 30′ with ring gear 31′, and so on for the next gear.

This radially-staggered arrangement allows the several coupling shafts 25,25′ and 25″, which are carried around the hub axis by hub rotation, to pass motor shafts 35, 35′ and 35″, respectively, which are supported on the relatively-stationary nacelle, without interference. Thus, coupling shaft 25′ passes between ring gears 31 and 31′. Similarly, coupling shaft 25″ (not shown) passes between ring gears 31′ and 31″. Since the ring gears have only limited rotation with respect to the hub, due to the limited rotation of each blade about its axis, the angularly-spaced radial roller support arms can be located to allow the coupling shafts to pass between them.

As the hub rotates with the blade at a fixed pitch angle, the blade and coupling shaft 25′ sweep around the hub axis x-x and carry the meshed ring gear 31′ at the same rotational speed. The motor shaft 35′, also meshed with ring gear 31′ by gear 39′, must therefore be driven at a speed to allow the ring gear to rotate at the speed of the hub. It should be noted that power must be constantly supplied to the motor to rotate its output shaft, and to resist the aerodynamic reaction torque on the blade.

To control the blade pitch angle, the motor 34′ is transiently speeded up or slowed down so that ring gear 31′ will be caused to rotate somewhat with respect to the hub, thereby rotating gear 30′ on coupling shaft 25′ and thus causing the pitch of the associated blade about axis y-y to be selectively changed.

Hence, in this particular form, the mechanism for controlling the pitch of each blade on the rotating hub is mechanically connected via a gear train to a motor which is mounted on the relatively-stationary nacelle. This avoids the need for electrically-conductive slip rings or the like, which would otherwise be required if the motor were to be mounted on the hub for rotation therewith.

An additional desirable feature of this mechanism is its inherent fail-safe behavior. In the event of a failure of the pitch control system, the motors may be short-circuited to remove blade-holding torque and to provide dynamic braking so that the blades will tend to feather slowly and provide drag to safely bring the rotor to a stop.

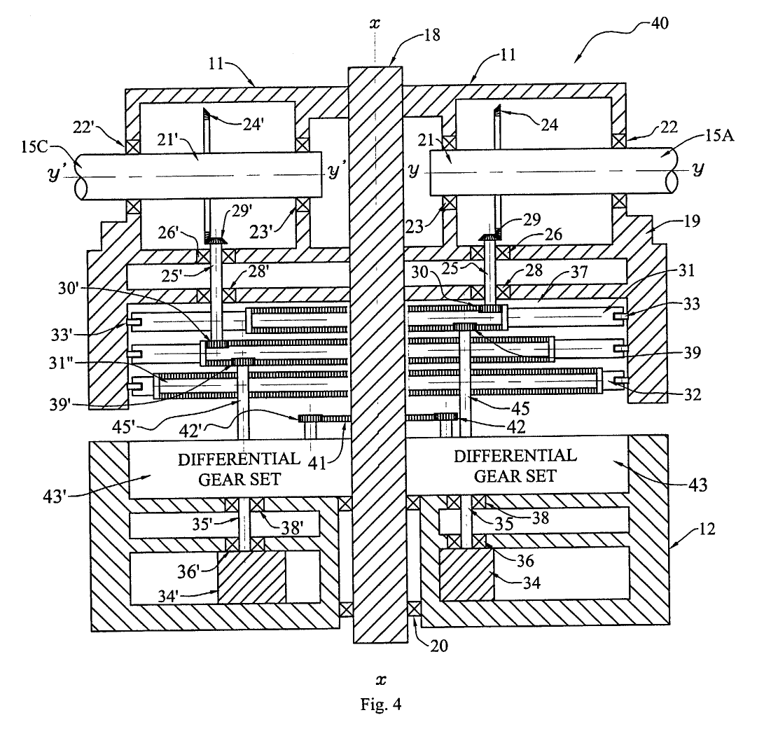

Second Embodiment (FIG. 4)

FIG. 4 is a view, partly in section and partly in elevation, of a second form of the improved mechanism, generally indicated at 40. This mechanism is identical to that shown in FIG. 2 with the addition of the elements described here. A motor, again indicated at 34, is operatively associated with an individual blade via a ring gear 31, but in this case is coupled through a differential gear set 43 mounted on the nacelle. An additional gear 41 is mounted fast to hub shaft 18 for rotation therewith. This gear is in meshed engagement with gear 44 so as to be operatively engaged via a coupling shaft 42 with the differential gear set, having another coupling shaft 45 with gear 46 mounted on its distal end and in meshed engagement with ring gear 31.

The differential gear set is a well-known mechanical mechanism which can take many forms, including planetary gearing, and will not be described in detail herein. Functionally, the angular displacement of motor shaft 35 is proportional to the difference in the angular displacements of shafts 42 and 45. The gear ratios of coupling shafts 42 and 45 are selected so that gear 45 will drive gear 31 at the same angular speed as gear 41; i.e., in synchronism with the hub rotational speed. Thus, when the pitch of the associated blade is to be held constant, shafts 42 and 31 will rotate at the same speed, and the motor output shaft 35 need not be rotated, although the motor must still provide reaction torque. When motor 34 is operated, a proportional angular displacement will be introduced between gear 41 and gear 31, thus creating a proportional change in the blade pitch angle. This arrangement therefore affords the capability of energy saving when the blade pitch is to remain constant.

Modifications

The present invention expressly contemplates that various changes and modifications may be made. For example, the structure of the hub and nacelle may be readily changed or modified. The blade gear need not necessarily be a bevel gear that completely surrounds the shaft. It might alternatively be a toothed sector connected to the associated blade shaft. The means or mechanism for coupling the motor output shaft to the associated blade shaft is not limited to a gear train or to a differential gear set. Other types of coupling mechanisms might alternatively be employed.

Specifically, the preferred embodiment shown in FIGS. 2 and 3 illustrates ring gears having internal gear teeth and staggered diameters to permit the coupling shafts 25 to pass outside of, and between the bearing support arms of, adjacent rings. However, if the coupling from each of the ring gears to the blade shafts is alternatively formed on the outer diameter of each of the rings over a limited sector angle between bearing support arms, the ring gears need not have staggered diameters, but may all have internal teeth at the same diameter meshing with the associated motor coupling shaft gears at the same radius form the hub axis.

Therefore, while several preferred forms of the inventive mechanism have been shown and described, and several modifications thereof discussed, persons skilled in this art will readily appreciate that various additional changes and modifications may be made without departing from the spirit of the invention, as defined and differentiated by the appended claims. In the following claims, preamble language in a claim that is not referred to in the body of that particular claim is to be construed as a statement of intended use, and not as a limitation.

What is claimed is:

1. A mechanism for controlling independently the pitch of each of a plurality of blades of a wind turbine, comprising:
a hub rotatable about an axis relative to a nacelle;
a plurality of blades mounted on said hub for rotation therewith about said hub axis, each blade having a shaft and being mounted on said hub for rotation about its axis of elongation;
a corresponding plurality of motors mounted on said nacelle, each motor having an output shaft and being associated with a respective one of said blades; and
a corresponding plurality of coupling mechanisms operatively interposed between each motor and its associated blade for selectively rotating such blade about its axis to vary the pitch of said associated blade relative to said hub axis;
whereby the pitch of each blade may be controlled independently of that of the others.

2. A mechanism as set forth in claim 1 wherein said motor is an electric motor.

3. A mechanism as set forth in claim 1 wherein said blade axis is perpendicular to said hub axis.

4. A mechanism as set forth in claim 1 wherein each coupling mechanism includes a gear train.

5. A mechanism as set forth in claim 4 wherein said gear train includes a first gear mounted on said blade shaft, a second gear mounted on said motor shaft, and an intermediate gear rotatably mounted on one of said hub and nacelle in a manner concentric with said hub axis and coupled to said first and second gears.

6. A mechanism as set forth in claim 5 wherein said intermediate gear is arranged for continuous 360° rotation with said hub in meshed engagement with said second gear.

7. A mechanism as set froth in claim 5 wherein said intermediate gear is arranged for limited angular displacement with respect to said hub in meshed engagement with said first gear.

8. A mechanism as set forth in claim 7 wherein said intermediate gear and said first gear are arranged such that the meshing teeth of each gear are provided on angular sectors.

9. A mechanism as set forth in claim 4 wherein said intermediate gears are spaced along said hub axis.

10. A mechanism as set forth in claim 9 wherein said intermediate gears have different meshing diameters with respect to said first and second gears.

11. A mechanism as set forth in claim 9 wherein the coupling mechanism between one of said first and second gears and one of said intermediate gears passes through an opening in another of said intermediate gears.

12. A mechanism as set forth in claim 5 and further comprising:
a differential gear set mounted on said nacelle and operatively interposed between said motor shaft and said intermediate gear.

13. A mechanism as set forth in claim 12 wherein said differential gear set has an input shaft coupled to said motor shaft, an output shaft coupled to said intermediate gear, and a reference shaft coupled to rotate with said hub, and wherein said differential gear set is operatively arranged such that the output shaft rotation is proportional to the algebraic sum of the angular rotations of said input shaft and said reference shaft.

14. The mechanism as set forth in claim 1 and further comprising an intermediate ring gear associated with each blade.

15. The mechanism as set forth in claim 14 wherein said ring gears have different diameters.

16. The mechanism as set forth in claim 15 wherein each coupling mechanism includes a coupling shaft, and wherein the coupling shaft of at least one of said coupling mechanisms is arranged outside the ring gear of another of said coupling mechanisms.
